(19) United States
(12) Patent Application Publication
(10) Pub. No.: US 2024/0406904 A1
(43) Pub. Date: Dec. 5, 2024

(54) COORDINATING DUAL REGISTRATION

(71) Applicant: Lenovo (Singapore) Pte. Ltd., New Tech Park (SG)

(72) Inventors: Sheeba Backia Mary Baskaran, Friedrichsdorf (DE); Emmanouil Pateromichelakis, Viersen (DE); Andreas Kunz, Ladenburg (DE)

(21) Appl. No.: 18/697,352

(22) PCT Filed: Nov. 11, 2021
(86) PCT No.: PCT/EP2021/081436

§ 371 Date: Mar. 29, 2024

(30) Foreign Application Priority Data
Oct. 5, 2021 (GR) 20210100678

(51) Int. Cl. H04W 60/00; H04W 12/08

(52) U.S. Cl. CPC H04W 60/005; H04W 12/08

(57) ABSTRACT

Apparatuses, methods, and systems are disclosed for coordinating dual registration. One method includes transmitting, to an edge interworking service, a first request message including: an application profile; primary security information; secondary security information; and a requested dual registration area. The method includes receiving, from the edge interworking service, a first response message including: a coordinated expiration time; a dual registration identifier; and a combined allowed dual registration area.

### FIELD

The subject matter disclosed herein relates generally to wireless communications and more particularly relates to coordinating dual registration.

### BACKGROUND

In certain wireless communications networks, dual registration may be performed. In such networks, the two registrations may not operate well together.

### BRIEF SUMMARY

Methods for coordinating dual registration are disclosed. Apparatuses and systems also perform the functions of the methods. One embodiment of a method includes transmitting, to an edge interworking service, a first request message including: an application profile; primary security information; secondary security information; and a requested dual registration area. In some embodiments, the method includes receiving, from the edge interworking service, a first response message including: a coordinated expiration time; a dual registration identifier; and a combined allowed dual registration area.

One apparatus for coordinating dual registration includes an application server. In some embodiments, the apparatus includes a transmitter that transmits, to an edge interworking service, a first request message including: an application profile; primary security information; secondary security information; and a requested dual registration area. In various embodiments, the apparatus includes a receiver that receives, from the edge interworking service, a first response message including: a coordinated expiration time; a dual registration identifier; and a combined allowed dual registration area.

Another embodiment of a method for coordinating dual registration includes receiving, from an application server, a first request message including: an application profile; primary security information; secondary security information; and a requested dual registration area. In some embodiments, the method includes determining, based on the request message, whether to transmit a second request message to a primary dual registration system. In certain embodiments, the method includes, in response to determining to transmit the second request message to the primary dual registration system, transmitting the second request message to the primary dual registration system, wherein the second request message comprises: the application profile; the primary security information; and the requested dual registration area. In various embodiments, the method includes receiving, from the primary dual registration system, a second response message including: a coordinated expiration time; a dual registration identifier; and a first allowed dual registration area.

Another apparatus for coordinating dual registration includes an edge interworking service. In some embodiments, the apparatus includes a receiver that receives, from an application server, a first request message including: an application profile; primary security information; secondary security information; and a requested dual registration area. In various embodiments, the apparatus includes a processor that determines, based on the request message, whether to transmit a second request message to a primary dual registration system. In some embodiments, the apparatus includes a transmitter that, in response to determining to transmit the second request message to the primary dual registration system, transmits the second request message to the primary dual registration system, wherein the second request message comprises: the application profile; the primary security information; and the requested dual registration area. In certain embodiments, the receiver receives, from the primary dual registration system, a second response message including: a coordinated expiration time; a dual registration identifier; and a first allowed dual registration area.

A further embodiment of a method for coordinating dual registration includes receiving, from an edge interworking service, a second request message including: an application profile; primary security information; and a requested dual registration area. In some embodiments, the method includes performing authorization for a primary registration based on: the primary security information, a local policy, the requested dual registration area, or some combination thereof. In certain embodiments, the method includes, in response to the authorization for the primary registration being successful: setting a first allowed dual registration area specific to the primary dual registration system for an application server; setting a coordinated expiration time; setting a dual registration identifier; and storing information indicating the first allowed dual registration area. In various embodiments, the method includes transmitting, to the edge interworking service, a second response message including: the coordinated expiration time; the dual registration identifier; and the first allowed dual registration area.

A further apparatus for coordinating dual registration includes a primary dual registration system. In some embodiments, the apparatus includes a receiver that receives, from an edge interworking service, a second request message including: an application profile; primary security information; and a requested dual registration area. In various embodiments, the apparatus includes a processor that: performs authorization for a primary registration based on: the primary security information, a local policy, the requested dual registration area, or some combination thereof; in response to the authorization for the primary registration being successful: sets a first allowed dual registration area specific to the primary dual registration system for an application server; sets a coordinated expiration time; sets a dual registration identifier; and stores information indicating the first allowed dual registration area, the coordinated expiration time, and the dual registration identifier. In some embodiments, the apparatus includes a transmitter that transmits, to the edge interworking service, a second response message including: the coordinated expiration time; the dual registration identifier; and the first allowed dual registration area.

A further embodiment of a method for coordinating dual registration includes receiving, from an edge interworking service, a third request message including: an application profile; secondary security information; a coordinated expiration time; a dual registration identifier; and a requested dual registration area. In some embodiments, the method includes performing authorization for a secondary registration based on: the secondary security information, a local policy, the requested dual registration area, or some combination thereof. In certain embodiments, the method includes, in response to the authorization for the secondary registration being successful: setting a second allowed dual registration area specific to the secondary dual registration system for an application server; and storing information indicating the second allowed dual registration area, the coordinated expiration time, and the dual registration identifier. In various embodiments, the method includes transmitting, to the edge interworking service, a third response message including: the coordinated expiration time; the dual registration identifier; and the second allowed dual registration area.

A further apparatus for coordinating dual registration includes a secondary dual registration system. In some embodiments, the apparatus includes a receiver that receives, from an edge interworking service, a third request message including: an application profile; secondary security information; a coordinated expiration time; a dual registration identifier; and a requested dual registration area. In various embodiments, the apparatus includes a processor that: performs authorization for a secondary registration based on: the secondary security information, a local policy, the requested dual registration area, or some combination thereof; in response to the authorization for the secondary registration being successful: sets a second allowed dual registration area specific to the secondary dual registration system for an application server; and sets information indicating the second allowed dual registration area, the coordinated expiration time, and the dual registration identifier. In some embodiments, the apparatus includes a transmitter that transmits, to the edge interworking service, a third response message including: the coordinated expiration time; the dual registration identifier; and the second allowed dual registration area.

Yet another embodiment of a method for coordinating dual registration includes transmitting, to a primary dual registration system, a first request message including: an application profile; primary security information; secondary security information; and a requested dual registration area. In some embodiments, the method includes receiving, from the primary dual registration system, a first response message including: a coordinated expiration time; a dual registration identifier; and a combined allowed dual registration area.

Yet another apparatus for coordinating dual registration includes an application server. In some embodiments, the apparatus includes a transmitter that transmits, to a primary dual registration system, a first request message including: an application profile; primary security information; secondary security information; and a requested dual registration area. In various embodiments, the apparatus includes a receiver that receives, from the primary dual registration system, a first response message including: a coordinated expiration time; a dual registration identifier; and a combined allowed dual registration area. As used herein, a combined allowed dual registration area may include an allowed registration area specific to the primary dual registration system and an allowed registration area specific to the secondary dual registration system.

A further embodiment of a method for coordinating dual registration includes receiving, from an application server, a first request message including: an application profile; primary security information; secondary security information; and a requested dual registration area. In some embodiments, the method includes performing authorization for a primary registration based: the primary security information, a local policy, the requested dual registration area, or some combination thereof. In certain embodiments, the method includes, in response to the authorization for the primary registration being successful: setting a first allowed dual registration area specific to the primary dual registration system for an application server; setting a coordinated expiration time; setting a dual registration identifier; and storing information indicating the first allowed dual registration area, the coordinated expiration time, and the dual registration identifier. In various embodiments, the method includes transmitting, to a secondary dual registration system, a second request message including: the secondary security information; the coordinated expiration time; the dual registration identifier; and the requested dual registration area. In some embodiments, the method includes receiving, from the secondary dual registration system, a second response message including: the coordinated expiration time; the dual registration identifier; and a second allowed dual registration area. In certain embodiments, the method includes transmitting, to the application server, a first response message including: the coordinated expiration time; the dual registration identifier; and a combined allowed dual registration area determined based on the first allowed dual registration area and the second allowed dual registration area.

A further apparatus for coordinating dual registration includes a primary dual registration system. In some embodiments, the apparatus includes a receiver that receives, from an application server, a first request message including: an application profile; primary security information; secondary security information; and a requested dual registration area. In various embodiments, the apparatus includes a processor that: performs authorization for a primary registration based: the primary security information, a local policy, the requested dual registration area, or some combination thereof; in response to the authorization for the primary registration being successful: sets a first allowed dual registration area specific to the primary dual registration system for an application server; sets a coordinated expiration time; sets a dual registration identifier; and stores information indicating the first allowed dual registration area, the coordinated expiration time, and the dual registration identifier. In some embodiments, the apparatus includes a transmitter that transmits, to a secondary dual registration system, a second request message including: the secondary security information; the coordinated expiration time; the dual registration identifier; and the requested dual registration area. In certain embodiments: the receiver receives, from the secondary dual registration system, a second response message including: the coordinated expiration time; the dual registration identifier; and a second allowed dual registration area; and the transmitter transmits, to the application server, a first response message including: the coordinated expiration time; the dual registration identifier; and a combined allowed dual registration area determined based on the first allowed dual registration area and the second allowed dual registration area.

Another embodiment of a method for coordinating dual registration includes receiving, from a primary dual registration system, a second request message including: secondary security information; a coordinated expiration time; a dual registration identifier; and a requested dual registration area. In some embodiments, the method includes performing authorization for a secondary registration based on: the secondary security information, a local policy, the requested dual registration area, or some combination thereof. In certain embodiments, the method includes, in response to the authorization for the secondary registration being successful: setting a second allowed dual registration area specific to the secondary dual registration system for an application server; and storing information indicating the second allowed dual registration area, the coordinated expiration time, and the dual registration identifier. In various embodiments, the method includes transmitting, to the primary dual registration system, a second response message including: the coordinated expiration time; the dual registration identifier; and the second allowed dual registration area.

Another apparatus for coordinating dual registration includes a secondary dual registration system. In some embodiments, the apparatus includes a receiver that receives, from a primary dual registration system, a second request message including: secondary security information; a coordinated expiration time; a dual registration identifier; and a requested dual registration area. In various embodiments, the apparatus includes a processor that: performs authorization for a secondary registration based on: the secondary security information, a local policy, the requested dual registration area, or some combination thereof; in response to the authorization for the secondary registration being successful: sets a second allowed dual registration area specific to the secondary dual registration system for an application server; and stores information indicating the second allowed dual registration area, the coordinated expiration time, and the dual registration identifier. In some embodiments, the apparatus includes a transmitter that transmits, to the primary dual registration system, a second response message including: the coordinated expiration time; the dual registration identifier; and the second allowed dual registration area.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for coordinating dual registration;

FIG. 2 is a schematic block diagram illustrating one embodiment of an apparatus that may be used for coordinating dual registration;

FIG. 3 is a schematic block diagram illustrating one embodiment of an apparatus that may be used for coordinating dual registration;

FIG. 4 is a schematic block diagram illustrating one embodiment of a system for coordinating dual registration;

FIG. 5 is a schematic block diagram illustrating another embodiment of a system for coordinating dual registration;

FIG. 6 is a schematic block diagram illustrating a further embodiment of a system for coordinating dual registration;

FIG. 7 is a schematic block diagram illustrating yet another embodiment of a system for coordinating dual registration;

FIG. 8 is a flow chart diagram illustrating one embodiment of a method for coordinating dual registration;

FIG. 9 is a flow chart diagram illustrating another embodiment of a method for coordinating dual registration;

FIG. 10 is a flow chart diagram illustrating a further embodiment of a method for coordinating dual registration;

FIG. 11 is a flow chart diagram illustrating yet another embodiment of a method for coordinating dual registration;

FIG. 12 is a flow chart diagram illustrating an additional embodiment of a method for coordinating dual registration;

FIG. 13 is a flow chart diagram illustrating another embodiment of a method for coordinating dual registration; and

FIG. 14 is a flow chart diagram illustrating a further embodiment of a method for coordinating dual registration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the FIGS. illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated FIGURES.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

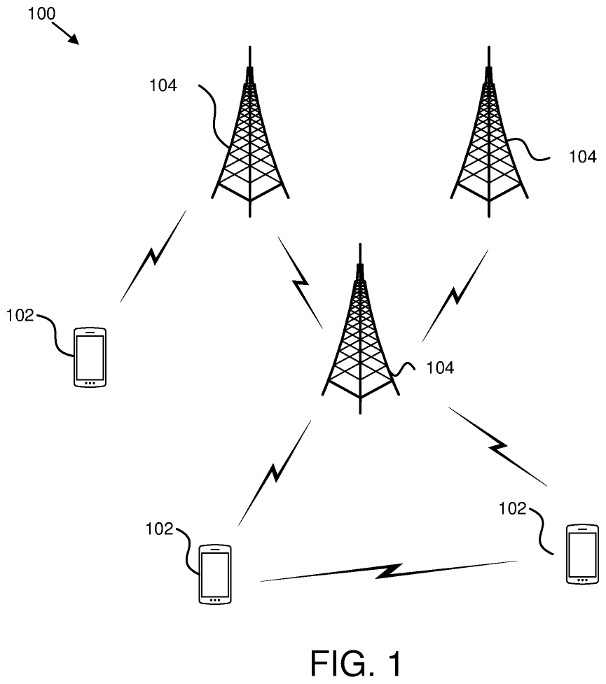

FIG. 1 depicts an embodiment of a wireless communication system 100 for coordinating dual registration. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), a primary dual registration system, a secondary dual registration system, an application server, an edge interworking service, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit, to an edge interworking service, a first request message including: an application profile; primary security information; secondary security information; and a requested dual registration area. In some embodiments, the network unit 104 may receive, from the edge interworking service, a first response message including: a coordinated expiration time; a dual registration identifier; and a combined allowed dual registration area. Accordingly, the network unit 104 may be used for coordinating dual registration.

In certain embodiments, a network unit 104 may receive, from an application server, a first request message including: an application profile; primary security information; secondary security information; and a requested dual registration area. In some embodiments, the network unit 104 may determine, based on the request message, whether to transmit a second request message to a primary dual registration system. In certain embodiments, the network unit 104 may, in response to determining to transmit the second request message to the primary dual registration system, transmit the second request message to the primary dual registration system, wherein the second request message comprises: the application profile; the primary security information; and the requested dual registration area. In various embodiments, the network unit 104 may receive, from the primary dual registration system, a second response message including: a coordinated expiration time; a dual registration identifier; and a first allowed dual registration area. Accordingly, the network unit 104 may be used for coordinating dual registration.

In some embodiments, a network unit 104 may receive, from an edge interworking service, a second request message including: an application profile; primary security information; and a requested dual registration area. In some embodiments, the network unit 104 may perform authorization for a primary registration based on: the primary security information, a local policy, the requested dual registration area, or some combination thereof. In certain embodiments, the network unit 104 may, in response to the authorization for the primary registration being successful: set a first allowed dual registration area specific to the primary dual registration system for an application server; setting a coordinated expiration time; set a dual registration identifier; and store information indicating the first allowed dual registration area. In various embodiments, the network unit 104 may transmit, to the edge interworking service, a second response message including: the coordinated expiration time; the dual registration identifier; and the first allowed dual registration area. Accordingly, the network unit 104 may be used for coordinating dual registration.

In various embodiments, a network unit 104 may receive, from an edge interworking service, a third request message including: an application profile; secondary security information; a coordinated expiration time; a dual registration identifier; and a requested dual registration area. In some embodiments, the network unit 104 may perform authorization for a secondary registration based on: the secondary security information, a local policy, the requested dual registration area, or some combination thereof. In certain embodiments, the network unit 104 may, in response to the authorization for the secondary registration being successful: set a second allowed dual registration area specific to the secondary dual registration system for an application server; and store information indicating the second allowed dual registration area, the coordinated expiration time, and the dual registration identifier. In various embodiments, the network unit 104 may transmit, to the edge interworking service, a third response message including: the coordinated expiration time; the dual registration identifier; and the second allowed dual registration area. Accordingly, the network unit 104 may be used for coordinating dual registration.

In certain embodiments, a network unit 104 may transmit, to a primary dual registration system, a first request message including: an application profile; primary security information; secondary security information; and a requested dual registration area. In some embodiments, the network unit 104 may receive, from the primary dual registration system, a first response message including: a coordinated expiration time; a dual registration identifier; and a combined allowed dual registration area. Accordingly, the network unit 104 may be used for coordinating dual registration.

In some embodiments, a network unit 104 may receive, from an application server, a first request message including: an application profile; primary security information; secondary security information; and a requested dual registration area. In some embodiments, the network unit 104 may perform authorization for a primary registration based: the primary security information, a local policy, the requested dual registration area, or some combination thereof. In certain embodiments, the network unit 104 may, in response to the authorization for the primary registration being successful: set a first allowed dual registration area specific to the primary dual registration system for an application server; set a coordinated expiration time; setting a dual registration identifier; and store information indicating the first allowed dual registration area, the coordinated expiration time, and the dual registration identifier. In various embodiments, the network unit 104 may transmit, to a secondary dual registration system, a second request message including: the secondary security information; the coordinated expiration time; the dual registration identifier; and the requested dual registration area. In some embodiments, the network unit 104 may receive, from the secondary dual registration system, a second response message including: the coordinated expiration time; the dual registration identifier; and a second allowed dual registration area. In certain embodiments, the network unit 104 may transmit, to the application server, a first response message including: the coordinated expiration time; the dual registration identifier; and a combined allowed dual registration area determined based on the first allowed dual registration area and the second allowed dual registration area. Accordingly, the network unit 104 may be used for coordinating dual registration.

In various embodiments, a network unit 104 may receive, from a primary dual registration system, a second request message including: secondary security information; a coordinated expiration time; a dual registration identifier; and a requested dual registration area. In some embodiments, the network unit 104 may perform authorization for a secondary registration based on: the secondary security information, a local policy, the requested dual registration area, or some combination thereof. In certain embodiments, the network unit 104 may, in response to the authorization for the secondary registration being successful: set a second allowed dual registration area specific to the secondary dual registration system for an application server; and store information indicating the second allowed dual registration area, the coordinated expiration time, and the dual registration identifier. In various embodiments, the network unit 104 may transmit, to the primary dual registration system, a second response message including: the coordinated expiration time; the dual registration identifier; and the second allowed dual registration area. Accordingly, the network unit 104 may be used for coordinating dual registration.

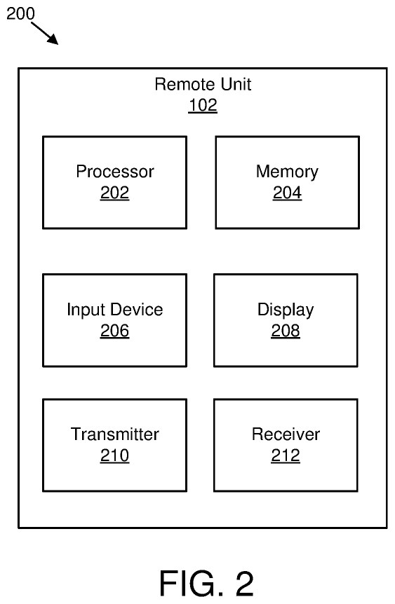

FIG. 2 depicts one embodiment of an apparatus 200 that may be used for coordinating dual registration. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

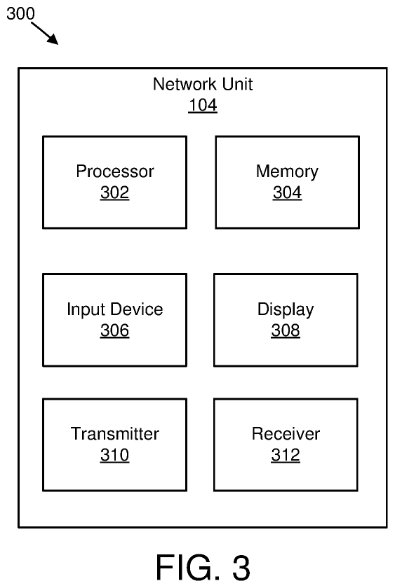

FIG. 3 depicts one embodiment of an apparatus 300 that may be used for coordinating dual registration. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits, to an edge interworking service, a first request message including: an application profile; primary security information; secondary security information; and a requested dual registration area. In various embodiments, the receiver 312 receives, from the edge interworking service, a first response message including: a coordinated expiration time; a dual registration identifier; and a combined allowed dual registration area. As used herein, a combined allowed dual registration area may include an allowed registration area specific to the primary dual registration system and an allowed registration area specific to the secondary dual registration system.

In some embodiments, the receiver 312 receives, from an application server, a first request message including: an application profile; primary security information; secondary security information; and a requested dual registration area. In various embodiments, the processor 302 determines, based on the request message, whether to transmit a second request message to a primary dual registration system. In some embodiments, the transmitter 310, in response to determining to transmit the second request message to the primary dual registration system, transmits the second request message to the primary dual registration system, wherein the second request message comprises: the application profile; the primary security information; and the requested dual registration area. In certain embodiments, the receiver 312 receives, from the primary dual registration system, a second response message including: a coordinated expiration time; a dual registration identifier; and a first allowed dual registration area.

In various embodiments, the receiver 312 receives, from an edge interworking service, a second request message including: an application profile; primary security information; and a requested dual registration area. In various embodiments, the processor 302: performs authorization for a primary registration based on: the primary security information, a local policy, the requested dual registration area, or some combination thereof; in response to the authorization for the primary registration being successful: sets a first allowed dual registration area specific to the primary dual registration system for an application server; sets a coordinated expiration time; sets a dual registration identifier; and stores information indicating the first allowed dual registration area, the coordinated expiration time, and the dual registration identifier. In some embodiments, the transmitter 310 transmits, to the edge interworking service, a second response message including: the coordinated expiration time; the dual registration identifier; and the first allowed dual registration area.

In various embodiments, the receiver 312 receives, from an edge interworking service, a third request message including: an application profile; secondary security information; a coordinated expiration time; a dual registration identifier; and a requested dual registration area. In various embodiments, the processor 302: performs authorization for a secondary registration based on: the secondary security information, a local policy, the requested dual registration area, or some combination thereof; in response to the authorization for the secondary registration being successful: sets a second allowed dual registration area specific to the secondary dual registration system for an application server; and sets information indicating the second allowed dual registration area, the coordinated expiration time, and the dual registration identifier. In some embodiments, the transmitter 310 transmits, to the edge interworking service, a third response message including: the coordinated expiration time; the dual registration identifier; and the second allowed dual registration area.

In certain embodiments, the transmitter 310 transmits, to a primary dual registration system, a first request message including: an application profile; primary security information; secondary security information; and a requested dual registration area. In various embodiments, the receiver 312 receives, from the primary dual registration system, a first response message including: a coordinated expiration time; a dual registration identifier; and a combined allowed dual registration area.

In some embodiments, the receiver 312 receives, from an application server, a first request message including: an application profile; primary security information; secondary security information; and a requested dual registration area. In various embodiments, the processor 302: performs authorization for a primary registration based: the primary security information, a local policy, the requested dual registration area, or some combination thereof; in response to the authorization for the primary registration being successful: sets a first allowed dual registration area specific to the primary dual registration system for an application server; sets a coordinated expiration time; sets a dual registration identifier; and stores information indicating the first allowed dual registration area, the coordinated expiration time, and the dual registration identifier. In some embodiments, the transmitter 310 transmits, to a secondary dual registration system, a second request message including: the secondary security information; the coordinated expiration time; the dual registration identifier; and the requested dual registration area. In certain embodiments: the receiver 312 receives, from the secondary dual registration system, a second response message including: the coordinated expiration time; the dual registration identifier; and a second allowed dual registration area; and the transmitter transmits, to the application server, a first response message including: the coordinated expiration time; the dual registration identifier; and a combined allowed dual registration area determined based on the first allowed dual registration area and the second allowed dual registration area.

In various embodiments, the receiver 312 receives, from a primary dual registration system, a second request message including: secondary security information; a coordinated expiration time; a dual registration identifier; and a requested dual registration area. In various embodiments, the processor 302: performs authorization for a secondary registration based on: the secondary security information, a local policy, the requested dual registration area, or some combination thereof; in response to the authorization for the secondary registration being successful: sets a second allowed dual registration area specific to the secondary dual registration system for an application server; and stores information indicating the second allowed dual registration area, the coordinated expiration time, and the dual registration identifier. In some embodiments, the transmitter 310 transmits, to the primary dual registration system, a second response message including: the coordinated expiration time; the dual registration identifier; and the second allowed dual registration area.

In certain embodiments, in a dual registration procedure, the following may occur: 1) the dual registration procedure supports only one security credentials information element (“IE”) and does not allow platform specific application server security credentials for authentication and/or authorization—this may impact security credentials secrecy among the platforms; and/or the existing dual registration procedure may allow only one expiry time to be provided in a dual registration response which may lead to expiry time desynchronization among primary and secondary edge platforms.

In some embodiments, a multi-access edge computing (“MEC”) and/or enhanced data rates for global evolution (“EDGE”) application dual registration includes: 1) enabling an application instance (e.g., such as an MEC application instance or EDGE application server) to provide primary system security credentials and secondary system security credentials to enable authorizations specific to a primary system and a secondary system respectively; 2) enabling an application instance to send a dual registration request to an edge interworking service (“EIS”) to trigger the primary system registration and secondary system registration via the EIS to support platform specific application authorization and registration; 3) enabling the primary registration system to co-ordinate an expiration time with the secondary system to ensure dual registration expiry time synchronization; and/or 4) enabling the primary registration system to co-ordinate with the secondary system on the dual registration area based on a required (e.g., from an edge application server (“EAS”) and/or MEC application) and an allowed (e.g., from an edge computing service provider (“ECSP”)) area where the dual registration may apply.

In a first embodiment, there may be enhancements to dual registration to support platform specific application authorization using an edge interworking platform.

The first embodiment describes how an application server may perform dual registration with a European telecommunications standards institute (“ETSI”) MEC platform and third generation partnership program (“3GPP”) edge enabler server (“EES”) based on the application security credentials specific to the respective platforms. In various embodiments: 1) an EIS may be used to enable interworking between an MEC Platform and a 3GPP EES in which a) the EIS can be termed an edge interworking platform (“EIP”), edge interworking function (“EIF”), and/or edge interworking framework, b) an EIS offered by any network or application function deployed by the 3GPP network operator, edge provider, global system for mobile communication (“GSM”) association (“GSMA”) operator platform group-if the EIS belongs to the 3GPP network, then a network exposure function (“NEF”), common application programming interface (“API”) framework (“CAPIF”), service enabler architecture layer (“SEAL”) enabler may perform the role of the EIP and/or EIF to offer the EIS, c) the EIP and/or EIS may be deployed by the ETSI MEC platform or mobile edge orchestrator (“MEO”), d) EIS is configured by MEO and 3GPP operational support system (“OSS”) (after the mutual discovery and pair selection notification procedure) about the platform pair selection information which includes a list of MEC platform and 3GPP EES pairing information and corresponding service capability information; 2) the application server such as EAS and MEC application instance may be configured with an address (e.g., uniform resource identifier (“URI”)) of the EIP and/or EIS to support dual registration; 3) the application server such as EAS and MEC application (“App”) instance that requires dual registration has the necessary security credentials specific to the primary registration system and secondary registration system to enable communication-such primary and secondary security credential configuration at the application server instance may be done if an application instance is instantiated, where the primary platform configures the primary security credential and secondary security credential in the application server instance-if security isolation has to be ensured between the primary and secondary registration systems and/or platforms, then the secondary security credentials may be configured by the primary registration in the application as received from the secondary platform and the Secondary security credential will be transparent to the primary platform; 4) the primary registration system co-ordinates an expiration time with the secondary system to ensure dual registration expiry time synchronization; and/or 5) the primary registration system co-ordinates with the secondary system on the “dual registration area” based on the required (e.g., from EAS and/or MEC App) and allowed (e.g., from the ECSP) area where the dual registration shall apply—the dual registration area may be termed as “Dual Registration Service Area” and it may be either a geographical and/or topological area specific to the primary and/or secondary registration system such as ETSI MEC platform and/or 3GPP EES service area.

In one instance of the first embodiment, there may be MEC App instance registration with a MEC platform as a primary registration system and a 3GPP EES as a secondary registration system.

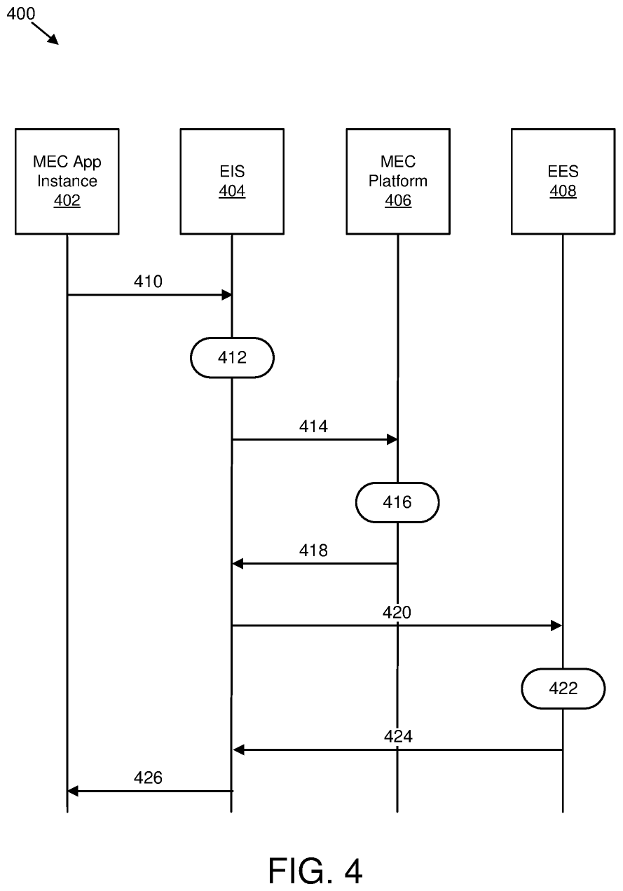

FIG. 4 is a schematic block diagram illustrating one embodiment of a system 400 for coordinating dual registration. Specifically, FIG. 4 illustrates an edge interworking framework for dual registration with ETSI MEC as a primary system. The system 400 includes an MEC application (App) instance 402, an EIS 404, a MEC platform 406, and an EES 408. It should be noted that each communication in the system 400 may include one or more messages.

In a first communication 410, the MEC application instance 402 sends a dual application registration request to the EIS 404 by setting the primary system as the MEC platform 406 and the secondary system as the EES 408 (e.g., 3GPP EES). The dual registration request may include: an application profile, primary security credentials of the MEC App (e.g., specific to the MEC platform 406), secondary security credentials of the MEC App (e.g., specific to the EES 408), a required dual registration service area, and/or an expiration (e.g., expiry) time.

The EIS 404 checks 412 the application profile (e.g., application identifier (“ID”)) with locally available dual registration platform association information and, if such a record exists, then the EIS 404 determines to forward the dual registration to the primary system on behalf of the MEC application instance 402.

In certain embodiments, the EIS 404 determines to send a primary application registration request to the MEC platform 406 on behalf of the MEC application instance 402.

In some embodiments, the EIS 404 selects an MEC platform and an EES pair as primary and secondary systems based on the received application profile of the MEC application instance 402 and the service capabilities of the MEC and EES platforms locally configured.

In a second communication 414, the EIS 404 sends a dual and/or primary application registration request to the MEC platform 406. The request to the MEC platform 406 may include: the application profile, primary security credentials, a required dual registration service area, and/or an expiration time.

The MEC platform 406 registers 416 the MEC application instance 402 (e.g., as a primary registration) by verifying the authorization based on the primary security credentials. If the primary registration is successful, the MEC platform 406 sets a coordinated expiration (e.g., expiry) time to be used for the dual registration phase for the MEC platform 406, the EES 408 (e.g., secondary system), and for the MEC application instance 402. Based on the received required dual registration service area and local policy, the MEC platform 406 sets an allowed dual registration service area for the application server (e.g., can be related to the primary registration system) and locally stores it.

In various embodiments, if the primary registration is not successful, then the MEC platform 406 determines to send a failure notification to the EIS 404.

In a third communication 418, the MEC platform 406 returns a primary and/or dual application registration acknowledgement message to the EIS 404. The acknowledgement message includes a success indication, a primary platform identifier, a dual registration ID, the allowed dual registration service area, and/or the coordinated expiration (e.g., expiry) time. The MEC platform 406 locally stores the application profile along with the dual registration ID, the allowed dual registration service area (e.g., specific to the primary registration system), and the coordinated expiration time.

In certain embodiments, the third communication 418 may include secondary platform identification information and/or an address for the secondary platform.

In some embodiments, if the primary registration is not successful, the MEC platform 406 returns a primary and/or dual application registration acknowledgement message to the EIS 404. Such a message includes a failure indication and cause value specific to the failure.

In a fourth communication 420, the EIS 404 sends a dual and/or secondary application registration request to the EES 408. The secondary application registration request includes: an application profile, secondary security credentials, the dual registration ID, the required dual registration service area, and/or the coordinated expiration time. The EIS 404 may discover the EES 408 based on a local configuration or based on secondary platform identification information and/or an address received from the primary platform.

The EES 408 platform registers 422 the MEC application instance 402 (e.g., as a secondary registration) by verifying the authorization based on the secondary security credentials. If the secondary registration is successful, the EES 408 platform stores the received coordinated expiration time and dual registration ID to be used for the dual registration phase along with the application profile for the MEC platform 406, the EES 408 (e.g., secondary system), and for the application instance. Based on the received required dual registration service area and local policy, the EES 408 sets an allowed dual registration service area for the application server (e.g., may be related to the secondary registration system) and locally stores it.

In a fifth communication 424, the EES 408 platform returns a secondary and/or dual application registration acknowledgement message to the EIS 404. This message may include: a success indication, a secondary platform identifier, the dual registration ID, the allowed dual registration service area for the application server, and/or the coordinated expiration time.

If, in step 422, the secondary registration is not successful, the EES 408 return a secondary and/or dual application registration acknowledgement message to the EIS 404. The message includes a failure indication and cause value specific to the failure.

In a sixth communication 426, the EIS 404 returns a dual application registration acknowledgement to the MEC application instance 402 which includes a success indication, the primary registration platform identifier, the secondary platform identifier, the dual registration ID, an allowed dual registration service area for the application server (e.g., can contain both primary registration and secondary registration system specific dual registration area information), and/or the coordinated expiration time.

In some embodiments, in step 426, if the secondary registration is not successful, the EIS 404 returns a dual application registration acknowledgement message to the MEC application instance 402. This message includes a failure indication and cause value specific to the failure.

In another instance of the first embodiment, there may be an interworking framework for dual registration with an EES as a primary registration system and an MEC platform as a secondary registration system.

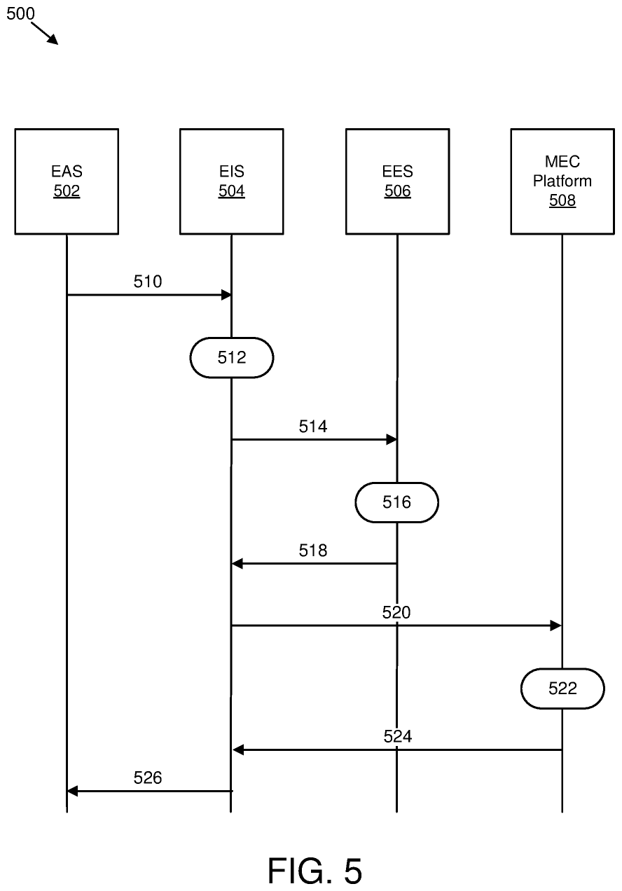

FIG. 5 is a schematic block diagram illustrating another embodiment of a system 500 for coordinating dual registration. Specifically, FIG. 5 illustrates an interworking framework for dual registration with an EES as the primary system. The system 500 includes an EDGE application server (“EAS”) 502, an EIS 504, a EES 506, and an MEC platform 508. It should be noted that each communication in the system 500 may include one or more messages.

In a first communication 510, the EAS 502 instance sends a dual application registration request to the EIS 504 by setting the primary system as the EES 506 and the secondary system as the MEC platform 508. The dual registration request may include: an application profile, primary security credentials of the EAS 502 (e.g., specific to the EES 506 platform), secondary security credentials of the EAS 502 (e.g., specific to the MEC platform 508), a required dual registration service area and/or an expiration (e.g., expiry) time.

The EIS 504 checks 512 the application profile (e.g., application ID such as EAS ID) with locally available dual registration platform association information and, if such a record exists, then the EIS 404 determines to forward the dual registration to the primary system on behalf of the EAS 502.

In certain embodiments, the EIS 504 determines to send a primary application registration request to the EES 506 on behalf of the EAS 502.

In some embodiments, the EIS 504 selects an EES pair and a MEC platform as primary and secondary systems based on the received application profile of the EAS 502 and the service capabilities of the EES platforms and MEC platform locally configured.

In a second communication 514, the EIS 504 sends a dual and/or primary application registration request to the EES 506. The request to the EES 506 may include: the application profile, primary security credentials, a required dual registration service area, and/or an expiration time.

The EES 506 registers 516 the EAS 502 application instance (e.g., as a primary registration) by verifying the authorization based on the primary security credentials. If the primary registration is successful, the EES 506 sets a coordinated expiration (e.g., expiry) time to be used for the dual registration phase for the EES 506, the MEC platform 508 (e.g., secondary system), and for the EAS 502 application instance. Based on the received required dual registration service area and local policy, the EES 506 sets an allowed dual registration service area for the application server (e.g., can be related to the primary registration system) and locally stores it.

In a third communication 518, the EES 506 returns a primary and/or dual application registration acknowledgement message to the EIS 504. The acknowledgement message includes a success indication, a primary platform identifier, a dual registration ID, the allowed dual registration service area, and/or the coordinated expiration (e.g., expiry) time. The EES 506 locally stores the application profile along with the dual registration ID, the allowed dual registration service area (e.g., specific to the primary registration system), and a coordinated expiration time.

In a fourth communication 520, the EIS 504 sends a dual and/or secondary application registration request to the MEC platform 508. The secondary application registration request includes: an application profile, secondary security credentials, the dual registration ID, the required dual registration service area, and/or the coordinated expiration time.

The MEC platform 508 registers the EAS 502 instance (e.g., as a secondary registration) by verifying the authorization based on the secondary security credentials. If the secondary registration is successful, the MEC platform 508 stores the received coordinated expiration time and dual registration ID to be used for the dual registration phase along with the application profile for the EES 506 (e.g., primary system), MEC platform 508 (e.g., secondary 20) system) and for the application instance. Based on the received required dual registration service area and local policy, the MEC platform 508 sets an allowed dual registration service area for the application server (e.g., may be related to the secondary registration system) and locally stores it.

In a fifth communication 524, the MEC platform 508 return a secondary and/or dual application registration acknowledgement message to the EIS 504. This message may include: a success indication, a secondary platform identifier, the dual registration ID, the allowed dual registration service area for the application server, and/or the coordinated expiration time.

In a sixth communication 526, the EIS 504 returns a dual application registration acknowledgement to the EAS 502 which includes a success indication, the primary registration platform identifier, the secondary platform identifier, the dual registration ID, an allowed dual registration service area for the application server (e.g., can contain both primary registration and secondary registration system specific dual registration area information), and/or the coordinated expiration time.

It should be noted that failure handling in dual registration may be the same for the EIS 504 as described in relation to FIG. 4. Moreover, the first embodiment may be applied for a dual application registration update procedure where steps 510 through 526 in the dual application registration procedure may correspond to the dual application registration update. Further, the first embodiment may be applied for a dual application registration de-registration procedure where steps 510 through 526 in the dual application registration procedure may correspond to the dual application registration de-registration.

In a second embodiment, there may be enhancement to dual registration to support coordination of expiration time between a primary registration system and a secondary registration system.

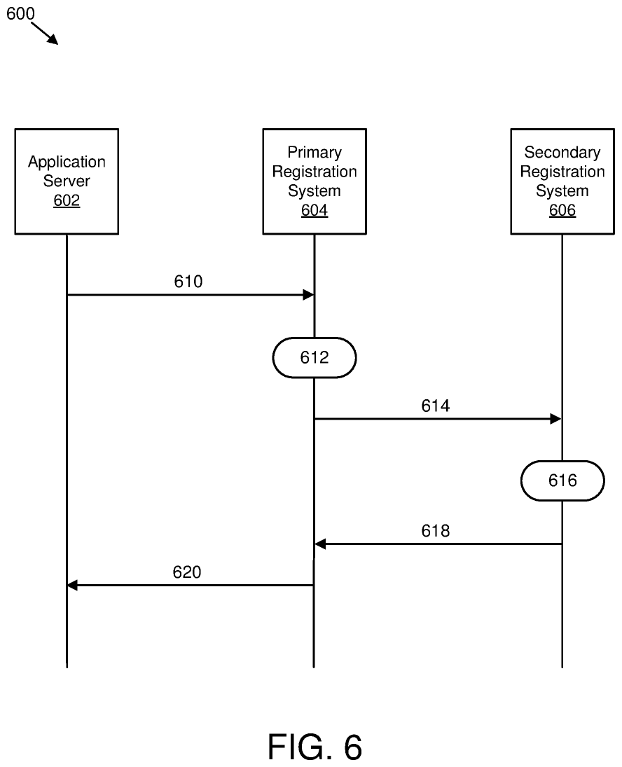

The second embodiment describes how the primary registration system can coordinate with the secondary registration system during dual registration to set a coordinated expiration time for the dual registration as shown in FIG. 6.

FIG. 6 is a schematic block diagram illustrating a further embodiment of a system 600 for coordinating dual registration. Specifically, FIG. 6 illustrates a coordination of expiration time among primary and secondary registration systems. The system 600 includes an application server 602, a primary registration system 604, and a secondary registration system 606. It should be noted that each communication in the system 600 may include one or more messages.

FIG. 6 shows two options as follows: 1) a first option: an MEC App instance performs dual registration with an MEC platform as the primary registration system 604 and an EES as the secondary registration system 606; and 2) a second option: an EAS performs dual registration with an EES as the primary registration system 604 and an MEC platform as the secondary registration system 606. For simplicity, the first option may be described in relation to FIG. 6, and the second option may be described as an alternative step.

In a first communication 610, the application server 602 (e.g., MEC application instance) sends a request to the primary registration system 604 (e.g., the MEC platform) to register itself with the option of dual registration (the EES is used as a secondary system). The dual registration request may include: an application profile, primary security credentials of the application and secondary security credentials of the application, a required dual registration service area, and/or an expiration (e.g., expiry) time.

The primary registration system 604 (e.g., MEC platform) registers 612 the application server 602 (e.g., MEC application instance) as a primary registration, and sets a dual registration ID and a coordinated expiration time (e.g., considering a received expiration time if received) to be used by the primary registration system 604, the secondary registration system 606, and the application server 602 instance. Based on the received required dual registration service area and local policy, the primary registration system 604 sets an allowed dual registration service area for the application server 602 (e.g., can be related to the primary registration system) and locally stores it.

In a second communication 614, the primary registration system 604 redirects the application registration request to the secondary registration system 606 on behalf of the application server 602. The application registration request includes: the received application profile, secondary credentials, the required dual registration service area, the dual registration ID, and the coordinated expiration time.

The secondary registration system 606 registers 616 the application instance (e.g., as secondary registration) based on the secondary credentials. The secondary registration system 606 stores the received coordinated expiration time and the dual registration ID in response to a successful secondary registration. Based on the received required dual registration service area and local policy, the secondary registration system 606 sets an allowed dual registration service area for the application server 602 (e.g., can be related to the secondary registration system) and locally stores it.

In a third communication 618, the secondary registration system 606 returns an application registration acknowledgement to the primary registration system 604 with the coordinated expiration time, the dual registration ID, and the allowed dual registration service area.

In a fourth communication 620, the primary registration system 604 returns a dual application registration acknowledgement to the application server 602 with an expiration time (e.g., set based on the coordinated expiration time), the dual registration ID, and a combined allowed required dual registration service area (e.g., can contain both primary registration and secondary registration system specific dual registration area information).

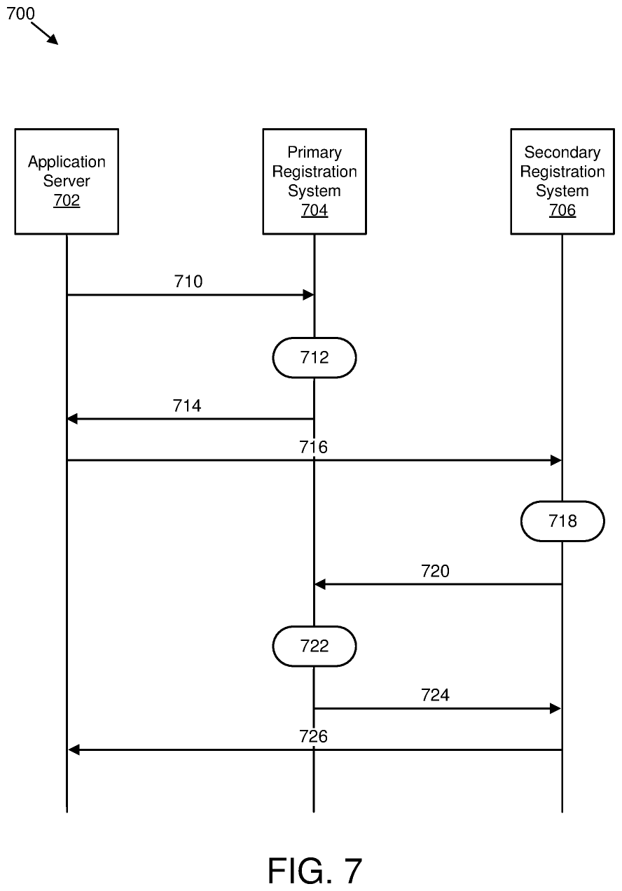

In some embodiments, a disadvantage of embodiments of FIG. 6 may be that the secondary security credentials are made visible to the primary system. This may be avoided by a separation of the dual registration procedure per a system, such as the system of FIG. 7.

FIG. 7 is a schematic block diagram illustrating yet another embodiment of a system 700 for coordinating dual registration. Specifically, FIG. 7 illustrates a coordination of an expiration time among primary and secondary registration systems with separate registration procedures. The system 700 includes an application server 702, a primary registration system 704, and a secondary registration system 706. It should be noted that each communication in the system 700 may include one or more messages.

In a first communication 710, the application server 702 sends a request to the primary registration system 704 to register itself (e.g., with the option of dual registration) with an indication of the secondary system. The dual registration request may include: an application profile, primary security credentials of the application, a required dual registration service area, and/or an expiration time.

The primary registration system 704 registers 712 the application server 702 (e.g., as a primary registration). Based on the received required dual registration service area and local policy, the primary registration system 704 sets an allowed dual registration service area for the application server 702 (e.g., may be related to the primary registration system) and locally stores it.

In a second communication 714, the primary registration system 704 returns a dual application registration acknowledgement to the application server 702 with the address of the secondary system and the allowed dual registration service area for the application server 702 (e.g., can be related to the primary registration system).

In a third communication 716, the application server 702 sends a request to the secondary registration system 706 to register itself (e.g., with the option of dual registration) with an indication of the primary system. The dual registration request may include: an application profile, secondary security credentials of the application, a required dual registration service area, and/or an expiration time.

The secondary registration system 706 registers the application server 702 (e.g., as a secondary registration). Based on the received required dual registration service area and local policy, the secondary registration system 706 sets an allowed dual registration service area for the application server 702 (e.g., can be related to the secondary registration system) and locally stores it.

In a fourth communication 720, the secondary registration system 706 sends an expiration time coordination Request to the primary registration system 704 including an application instance, the allowed dual registration service area for the application server 702 (e.g., can be related to the secondary registration system), the required dual registration service area, and/or the expiration time of the secondary registration system 706.

The primary registration system 704 sets 722 a coordinated expiration time (e.g., considering the received expiration time, if any) to be used by the primary registration system 704, the secondary registration system 706, and the application server 702. The primary registration system 704 verifies the received required dual registration service area with the locally stored allowed dual registration service area information.

In a fifth communication 724, the primary registration system 704 provides the coordinated expiration time and allowed dual registration service area to the secondary registration system 706 in an expiration coordination response message.

In a sixth communication 726, the secondary registration system 706 may confirm the allowed service area for the secondary registration system 706 based on the received allowed service area of primary registration system 704 and the required dual registration service area requested by the application server 702. The secondary registration system 706 returns a dual application registration acknowledgement to the application server 702 with the coordinated expiration time and allowed dual registration service area (e.g., can be related to the secondary registration system 706).

It should be noted that, the second embodiment may be applied for a dual application registration update procedure where steps 610 through 620 of FIG. 6 and steps 710 through 726 of FIG. 7 in the dual application registration procedure may correspond to the dual application registration update. Further, the second embodiment may be applied for a dual application registration de-registration procedure where steps 610 through 620 of FIG. 6 and steps 710 through 726 of FIG. 7 in the dual application registration procedure may correspond to the dual application registration de-registration.

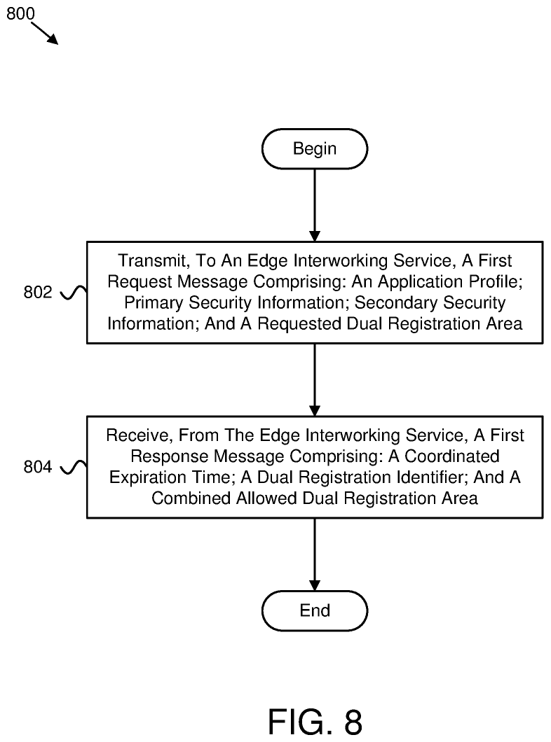

FIG. 8 is a flow chart diagram illustrating one embodiment of a method 800 for coordinating dual registration. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802, to an edge interworking service, a first request message including: an application profile; primary security information; secondary security information; and a requested dual registration area. In some embodiments, the method 800 includes receiving 804, from the edge interworking service, a first response message including: a coordinated expiration time; a dual registration identifier; and a combined allowed dual registration area.

In certain embodiments, the application server comprises a multi-access edge computing application instance or an edge application instance.

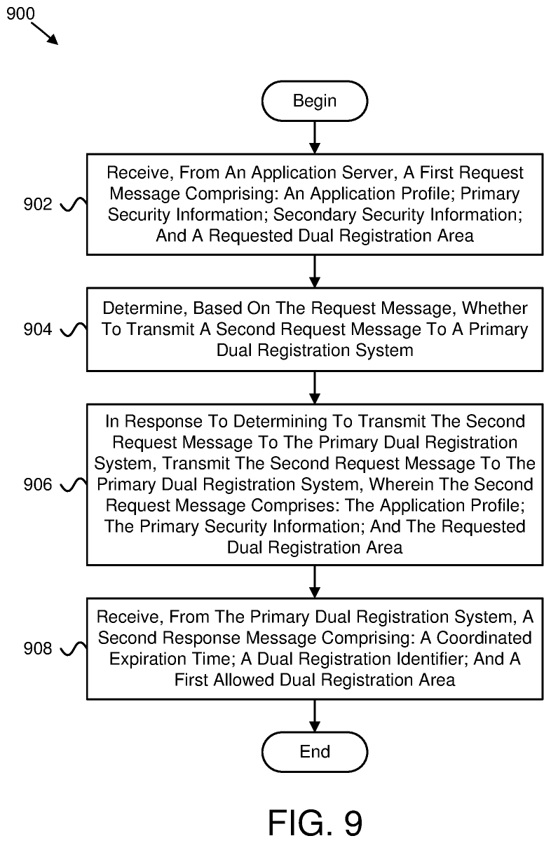

FIG. 9 is a flow chart diagram illustrating another embodiment of a method 900 for coordinating dual registration. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, from an application server, a first request message including: an application profile; primary security information; secondary security information; and a requested dual registration area. In some embodiments, the method 900 includes determining 904, based on the request message, whether to transmit a second request message to a primary dual registration system. In certain embodiments, the method 900 includes, in response to determining to transmit the second request message to the primary dual registration system, transmitting 906 the second request message to the primary dual registration system, wherein the second request message comprises: the application profile; the primary security information; and the requested dual registration area. In various embodiments, the method 900 includes receiving 908, from the primary dual registration system, a second response message including: a coordinated expiration time; a dual registration identifier; and a first allowed dual registration area.

In certain embodiments, the method 900 further comprises: in response to registration with the primary dual registration system being successful, transmitting a third request message to a secondary dual registration system, the third request message comprising: the application profile; the secondary security information; the coordinated expiration time; the dual registration identifier; and the requested dual registration area; receiving, from the secondary dual registration system, a third response message comprising: the coordinated expiration time; the dual registration identifier; and a second allowed dual registration area; and transmitting, to the application server, a first response message comprising: the coordinated expiration time; the dual registration identifier; and a combined allowed dual registration area determined based on the first allowed dual registration area and the second allowed dual registration area.

In some embodiments, the primary dual registration system, the secondary dual registration system, or a combination thereof comprises a multi-access edge computing platform or an edge enabler server. In various embodiments, determining, based on the request message, whether to transmit the second request message to the primary dual registration system comprises determining based on: the application profile, primary registration pairing information, secondary registration system pairing information, locally stored dual registration information about whether to transmit the second request message to the primary dual registration system, or some combination thereof.

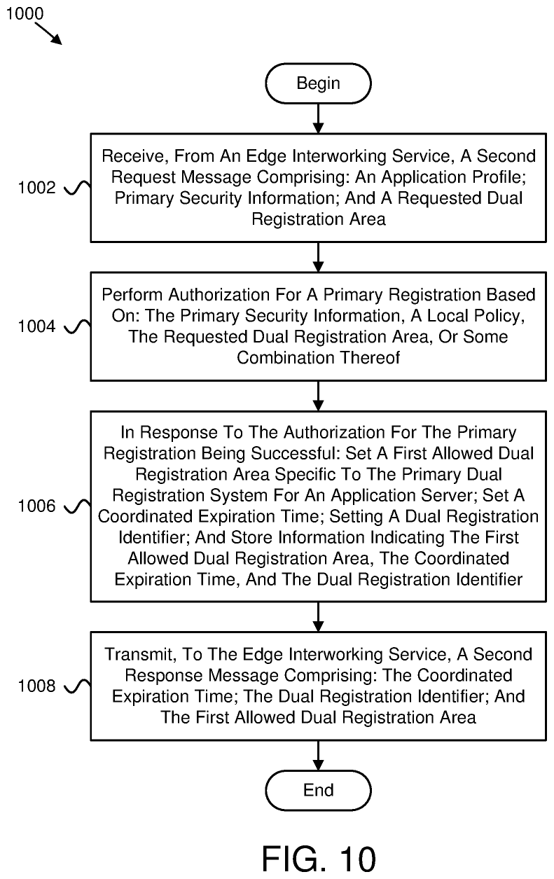

FIG. 10 is a flow chart diagram illustrating a further embodiment of a method 1000 for coordinating dual registration. In some embodiments, the method 900 is performed by an apparatus, such as the network unit 104. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002, from an edge interworking service, a second request message including: an application profile; primary security information; and a requested dual registration area. In some embodiments, the method 1000 includes performing 1004 authorization for a primary registration based on: the primary security information, a local policy, the requested dual registration area, or some combination thereof. In certain embodiments, the method 1000 includes, in response to the authorization for the primary registration being successful: setting 1006 a first allowed dual registration area specific to the primary dual registration system for an application server; setting a coordinated expiration time; setting a dual registration identifier; and storing information indicating the first allowed dual registration area. In various embodiments, the method 1000 includes transmitting 1008, to the edge interworking service, a second response message including: the coordinated expiration time; the dual registration identifier; and the first allowed dual registration area.

In certain embodiments, the primary dual registration system comprises a multi-access edge computing platform or an edge enabler server.

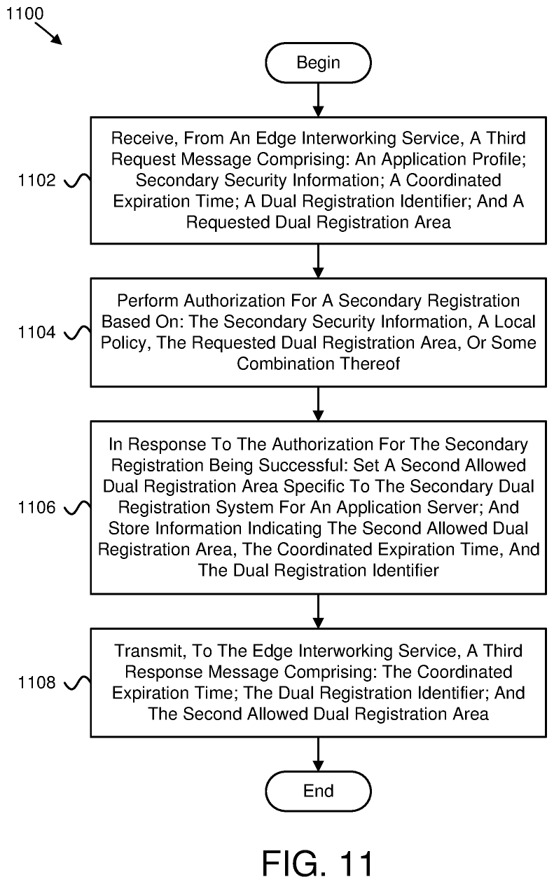

FIG. 11 is a flow chart diagram illustrating yet another embodiment of a method 1100 for coordinating dual registration. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes receiving 1102, from an edge interworking service, a third request message including: an application profile; secondary security information; a coordinated expiration time; a dual registration identifier; and a requested dual registration area. In some embodiments, the method 1100 includes performing 1104 authorization for a secondary registration based on: the secondary security information, a local policy, the requested dual registration area, or some combination thereof. In certain embodiments, the method 1100 includes, in response to the authorization for the secondary registration being successful: setting 1106 a second allowed dual registration area specific to the secondary dual registration system for an application server; and storing information indicating the second allowed dual registration area, the coordinated expiration time, and the dual registration identifier. In various embodiments, the method 1100 includes transmitting 1108, to the edge interworking service, a third response message including: the coordinated expiration time; the dual registration identifier; and the second allowed dual registration area.

In certain embodiments, the secondary dual registration system comprises a multi-access edge computing platform or an edge enabler server.

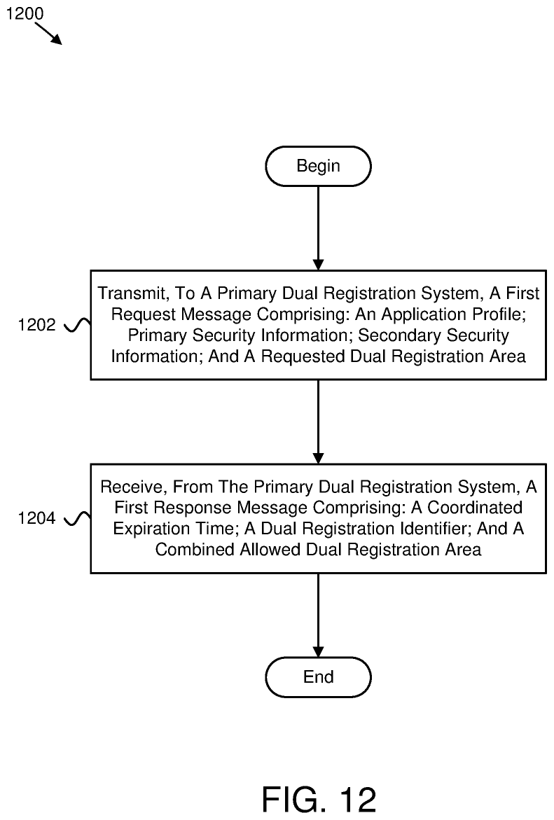

FIG. 12 is a flow chart diagram illustrating an additional embodiment of a method 1200 for coordinating dual registration. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes transmitting 1202, to a primary dual registration system, a first request message including: an application profile; primary security information; secondary security information; and a requested dual registration area. In some embodiments, the method 1200 includes receiving 1204, from the primary dual registration system, a first response message including: a coordinated expiration time; a dual registration identifier; and a combined allowed dual registration area.

In certain embodiments, the application server comprises a multi-access edge computing application instance or an edge application instance.

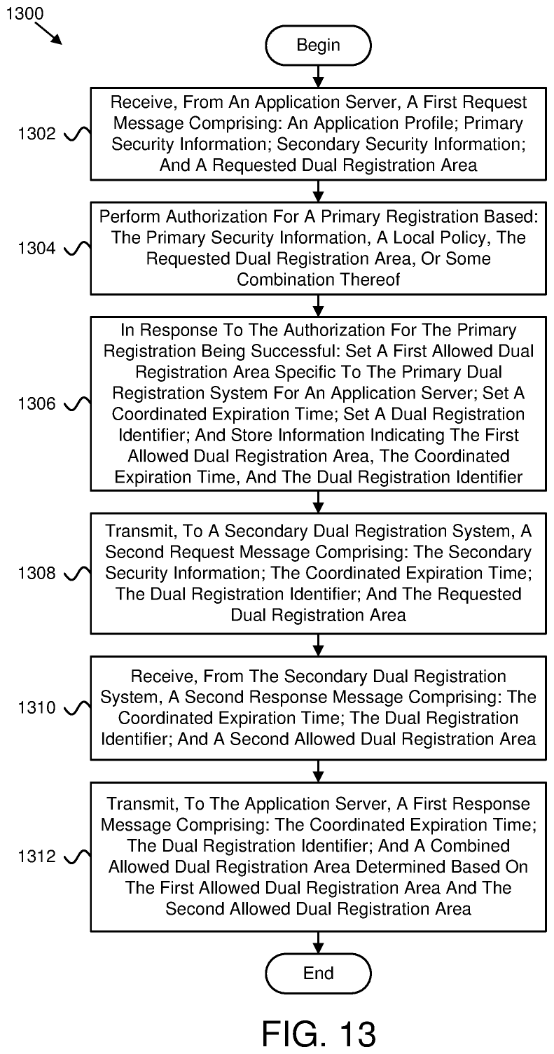

FIG. 13 is a flow chart diagram illustrating another embodiment of a method 1300 for coordinating dual registration. In some embodiments, the method 1300 is performed by an apparatus, such as the network unit 104. In certain embodiments, the method 1300 may be performed by a processor executing program code, for example, a microcontroller, a 25 microprocessor, a CPU, a GPU, an auxiliary processing unit, a FPGA, or the like.

In various embodiments, the method 1300 includes receiving 1302, from an application server, a first request message including: an application profile; primary security information; secondary security information; and a requested dual registration area. In some embodiments, the method 1300 includes performing 1304 authorization for a primary registration based: the primary security information, a local policy, the requested dual registration area, or some combination thereof. In certain embodiments, the method 1300 includes, in response to the authorization for the primary registration being successful: setting 1306 a first allowed dual registration area specific to the primary dual registration system for an application server; setting a coordinated expiration time; setting a dual registration identifier; and storing information indicating the first allowed dual registration area, the coordinated expiration time, and the dual registration identifier. In various embodiments, the method 1300 includes transmitting 1308, to a secondary dual registration system, a second request message including: the secondary security information; the coordinated expiration time; the dual registration identifier; and the requested dual registration area. In some embodiments, the method 1300 includes receiving 1310, from the secondary dual registration system, a second response message including: the coordinated expiration time; the dual registration identifier; and a second allowed dual registration area. In certain embodiments, the method 1300 includes transmitting 1312, to the application server, a first response message including: the coordinated expiration time; the dual registration identifier; and a combined allowed dual registration area determined based on the first allowed dual registration area and the second allowed dual registration area.

In certain embodiments, the primary dual registration system comprises a multi-access edge computing platform or an edge enabler server.

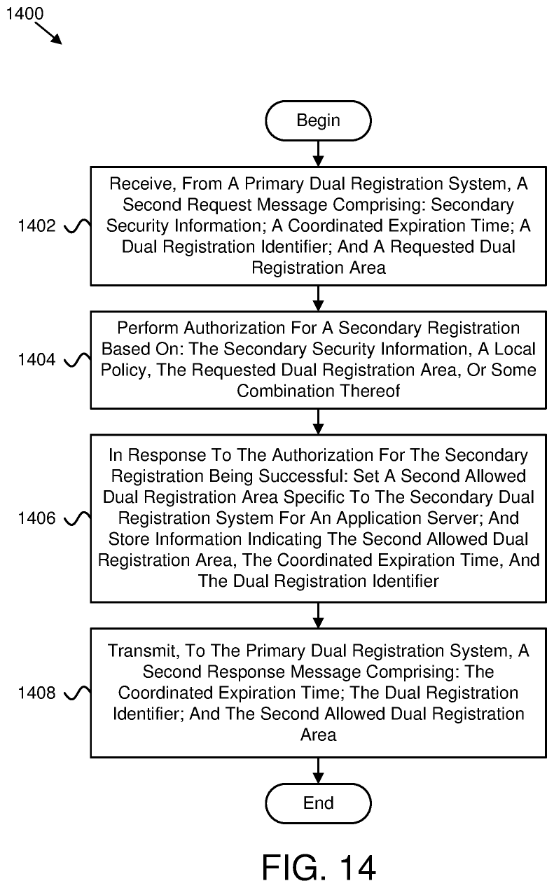

FIG. 14 is a flow chart diagram illustrating a further embodiment of a method 1400 for coordinating dual registration. In some embodiments, the method 1400 is performed by an apparatus, such as the network unit 104. In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes receiving 1402, from a primary dual registration system, a second request message including: secondary security information; a coordinated expiration time; a dual registration identifier; and a requested dual registration area. In some embodiments, the method 1400 includes performing 1404 authorization for a secondary registration based on: the secondary security information, a local policy, the requested dual registration area, or some combination thereof. In certain embodiments, the method 1400 includes, in response to the authorization for the secondary registration being successful: setting 1406 a second allowed dual registration area specific to the secondary dual registration system for an application server; and storing information indicating the second allowed dual registration area, the coordinated expiration time, and the dual registration identifier. In various embodiments, the method 1400 includes transmitting 1408, to the primary dual registration system, a second response message including: the coordinated expiration time; the dual registration identifier; and the second allowed dual registration area.

In certain embodiments, the secondary dual registration system comprises a multi-access edge computing platform or an edge enabler server.

In one embodiment, a method of an application server comprises: transmitting, to an edge interworking service, a first request message comprising: an application profile; primary security information; secondary security information; and a requested dual registration area; and receiving, from the edge interworking service, a first response message comprising: a coordinated expiration time; a dual registration identifier; and a combined allowed dual registration area.

In certain embodiments, the application server comprises a multi-access edge computing application instance or an edge application instance.

In one embodiment, an apparatus comprises an application server. The apparatus further comprises: a transmitter that transmits, to an edge interworking service, a first request message comprising: an application profile; primary security information; secondary security information; and a requested dual registration area; and a receiver that receives, from the edge interworking service, a first response message comprising: a coordinated expiration time; a dual registration identifier; and a combined allowed dual registration area.

In certain embodiments, the application server comprises a multi-access edge computing application instance or an edge application instance.

In one embodiment, a method of an edge interworking service comprises: receiving, from an application server, a first request message comprising: an application profile; primary security information; secondary security information; and a requested dual registration area; determining, based on the request message, whether to transmit a second request message to a primary dual registration system; in response to determining to transmit the second request message to the primary dual registration system, transmitting the second request message to the primary dual registration system, wherein the second request message comprises: the application profile; the primary security information; and the requested dual registration area; and receiving, from the primary dual registration system, a second response message comprising: a coordinated expiration time; a dual registration identifier; and a first allowed dual registration area.

In certain embodiments, the method further comprises: in response to registration with the primary dual registration system being successful, transmitting a third request message to a secondary dual registration system, the third request message comprising: the application profile; the secondary security information; the coordinated expiration time; the dual registration identifier; and the requested dual registration area; receiving, from the secondary dual registration system, a third response message comprising: the coordinated expiration time; the dual registration identifier; and a second allowed dual registration area; and transmitting, to the application server, a first response message comprising: the coordinated expiration time; the dual registration identifier; and a combined allowed dual registration area determined based on the first allowed dual registration area and the second allowed dual registration area.

In some embodiments, the primary dual registration system, the secondary dual registration system, or a combination thereof comprises a multi-access edge computing platform or an edge enabler server.

In various embodiments, determining, based on the request message, whether to transmit the second request message to the primary dual registration system comprises determining based on: the application profile, primary registration pairing information, secondary registration system pairing information, locally stored dual registration information about whether to transmit the second request message to the primary dual registration system, or some combination thereof.

In one embodiment, an apparatus comprises an edge interworking service. The apparatus further comprises: a receiver that receives, from an application server, a first request message comprising: an application profile; primary security information; secondary security information; and a requested dual registration area; a processor that determines, based on the request message, whether to transmit a second request message to a primary dual registration system; and a transmitter that, in response to determining to transmit the second request message to the primary dual registration system, transmits the second request message to the primary dual registration system, wherein the second request message comprises: the application profile; the primary security information; and the requested dual registration area; wherein the receiver receives, from the primary dual registration system, a second response message comprising: a coordinated expiration time; a dual registration identifier; and a first allowed dual registration area.

In certain embodiments: the transmitter, in response to registration with the primary dual registration system being successful, transmits a third request message to a secondary dual registration system, the third request message comprising: the application profile; the secondary security information; the coordinated expiration time; the dual registration identifier; and the requested dual registration area; the receiver receives, from the secondary dual registration system, a third response message comprising: the coordinated expiration time; the dual registration identifier; and a second allowed dual registration area; and the transmitter transmits, to the application server, a first response message comprising: the coordinated expiration time; the dual registration identifier; and a combined allowed dual registration area determined based on the first allowed dual registration area and the second allowed dual registration area.

In some embodiments, the primary dual registration system, the secondary dual registration system, or a combination thereof comprises a multi-access edge computing platform or an edge enabler server.

In various embodiments, the processor determining, based on the request message, whether to transmit the second request message to the primary dual registration system comprises the processor determining based on: the application profile, primary registration pairing information, secondary registration system pairing information, locally stored dual registration information about whether to transmit the second request message to the primary dual registration system, or some combination thereof.

In one embodiment, a method of a primary dual registration system comprises: receiving, from an edge interworking service, a second request message comprising: an application profile; primary security information; and a requested dual registration area; performing authorization for a primary registration based on: the primary security information, a local policy, the requested dual registration area, or some combination thereof; in response to the authorization for the primary registration being successful: setting a first allowed dual registration area specific to the primary dual registration system for an application server; setting a coordinated expiration time; setting a dual registration identifier; and storing information indicating the first allowed dual registration area, the coordinated expiration time, and the dual registration identifier; and transmitting, to the edge interworking service, a second response message comprising: the coordinated expiration time; the dual registration identifier; and the first allowed dual registration 20) area.

In certain embodiments, the primary dual registration system comprises a multi-access edge computing platform or an edge enabler server.

In one embodiment, an apparatus comprises a primary dual registration system. The apparatus further comprises: a receiver that receives, from an edge interworking service, a second request message comprising: an application profile; primary security information; and a requested dual registration area; a processor that: performs authorization for a primary registration based on: the primary security information, a local policy, the requested dual registration area, or some combination thereof; in response to the authorization for the primary registration being successful: sets a first allowed dual registration area specific to the primary dual registration system for an application server; sets a coordinated expiration time; sets a dual registration identifier; and stores information indicating the first allowed dual registration area, the coordinated expiration time, and the dual registration identifier; and a transmitter that transmits, to the edge interworking service, a second response message comprising: the coordinated expiration time; the dual registration identifier; and the first allowed dual registration area.

In certain embodiments, the primary dual registration system comprises a multi-access edge computing platform or an edge enabler server.

In one embodiment, a method of a secondary dual registration system comprises: receiving, from an edge interworking service, a third request message comprising: an application profile; secondary security information; a coordinated expiration time; a dual registration identifier; and a requested dual registration area; performing authorization for a secondary registration based on: the secondary security information, a local policy, the requested dual registration area, or some combination thereof; in response to the authorization for the secondary registration being successful: setting a second allowed dual registration area specific to the secondary dual registration system for an application server; and storing information indicating the second allowed dual registration area, the coordinated expiration time, and the dual registration identifier; and transmitting, to the edge interworking service, a third response message comprising: the coordinated expiration time; the dual registration identifier; and the second allowed dual registration area.

In certain embodiments, the secondary dual registration system comprises a multi-access edge computing platform or an edge enabler server.

In one embodiment, an apparatus comprises a secondary dual registration system. The apparatus further comprises: a receiver that receives, from an edge interworking service, a third request message comprising: an application profile; secondary security information; a coordinated expiration time; a dual registration identifier; and a requested dual registration area; a processor that: performs authorization for a secondary registration based on: the secondary security information, a local policy, the requested dual registration area, or some combination thereof; in response to the authorization for the secondary registration being successful: sets a second allowed dual registration area specific to the secondary dual registration system for an application server; and sets information indicating the second allowed dual registration area, the coordinated expiration time, and the dual registration identifier; and a transmitter that transmits, to the edge interworking service, a third response message comprising: the coordinated expiration time; the dual registration identifier; and the second allowed dual registration area.

In certain embodiments, the secondary dual registration system comprises a multi-access edge computing platform or an edge enabler server.

In one embodiment, a method of an application server comprises: transmitting, to a primary dual registration system, a first request message comprising: an application profile; primary security information; secondary security information; and a requested dual registration area; and receiving, from the primary dual registration system, a first response message comprising: a coordinated expiration time; a dual registration identifier; and a combined allowed dual registration area.

In certain embodiments, the application server comprises a multi-access edge computing application instance or an edge application instance.

In one embodiment, an apparatus comprises an application server. The apparatus further comprises: a transmitter that transmits, to a primary dual registration system, a first request message comprising: an application profile; primary security information; secondary security information; and a requested dual registration area; and a receiver that receives, from the primary dual registration system, a first response message comprising: a coordinated expiration time; a dual registration identifier; and a combined allowed dual registration area.

In certain embodiments, the application server comprises a multi-access edge computing application instance or an edge application instance.

In one embodiment, a method of a primary dual registration system comprises: receiving, from an application server, a first request message comprising: an application profile; primary security information; secondary security information; and a requested dual registration area; performing authorization for a primary registration based: the primary security information, a local policy, the requested dual registration area, or some combination thereof; in response to the authorization for the primary registration being successful: setting a first allowed dual registration area specific to the primary dual registration system for an application server; setting a coordinated expiration time; setting a dual registration identifier; and storing information indicating the first allowed dual registration area, the coordinated expiration time, and the dual registration identifier; transmitting, to a secondary dual registration system, a second request message comprising: the secondary security information; the coordinated expiration time; the dual registration identifier; and the requested dual registration area; receiving, from the secondary dual registration system, a second response message comprising: the coordinated expiration time; the dual registration identifier; and a second allowed dual registration area; and transmitting, to the application server, a first response message comprising: the coordinated expiration time; the dual registration identifier; and a combined allowed dual registration area determined based on the first allowed dual registration area and the second allowed dual registration area.

In certain embodiments, the primary dual registration system comprises a multi-access edge computing platform or an edge enabler server.

In one embodiment, an apparatus comprises a primary dual registration system. The apparatus further comprises: a receiver that receives, from an application server, a first request message comprising: an application profile; primary security information; secondary security information; and a requested dual registration area; a processor that: performs authorization for a primary registration based: the primary security information, a local policy, the requested dual registration area, or some combination thereof; in response to the authorization for the primary registration being successful: sets a first allowed dual registration area specific to the primary dual registration system for an application server; sets a coordinated expiration time; sets a dual registration identifier; and stores information indicating the first allowed dual registration area, the coordinated expiration time, and the dual registration identifier; and a transmitter that transmits, to a secondary dual registration system, a second request message comprising: the secondary security information; the coordinated expiration time; the dual registration identifier; and the requested dual registration area; wherein: the receiver receives, from the secondary dual registration system, a second response message comprising: the coordinated expiration time; the dual registration identifier; and a second allowed dual registration area; and the transmitter transmits, to the application server, a first response message comprising: the coordinated expiration time; the dual registration identifier; and a combined allowed dual registration area determined based on the first allowed dual registration area and the second allowed dual registration area.

In certain embodiments, the primary dual registration system comprises a multi-access edge computing platform or an edge enabler server.

In one embodiment, a method of a secondary dual registration system comprises: receiving, from a primary dual registration system, a second request message comprising: secondary security information; a coordinated expiration time; a dual registration identifier; and a requested dual registration area; performing authorization for a secondary registration based on: the secondary security information, a local policy, the requested dual registration area, or some combination thereof; in response to the authorization for the secondary registration being successful: setting a second allowed dual registration area specific to the secondary dual registration system for an application server; and storing information indicating the second allowed dual registration area, the coordinated expiration time, and the dual registration identifier; and transmitting, to the primary dual registration system, a second response message comprising: the coordinated expiration time; the dual registration identifier; and the second allowed dual registration area.

In certain embodiments, the secondary dual registration system comprises a multi-access edge computing platform or an edge enabler server.

In one embodiment, an apparatus comprises a secondary dual registration system. The apparatus further comprises: a receiver that receives, from a primary dual registration system, a second request message comprising: secondary security information; a coordinated expiration time; a dual registration identifier; and a requested dual registration area; a processor that: performs authorization for a secondary registration based on: the secondary security information, a local policy, the requested dual registration area, or some combination thereof; in response to the authorization for the secondary registration being successful: sets a second allowed dual registration area specific to the secondary dual registration system for an application server; and stores information indicating the second allowed dual registration area, the coordinated expiration time, and the dual registration identifier; and a transmitter that transmits, to the primary dual registration system, a second response message comprising: the coordinated expiration time; the dual registration identifier; and the second allowed dual registration area.

In certain embodiments, the secondary dual registration system comprises a multi-access edge computing platform or an edge enabler server.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
transmit, to a first node, a first request message comprising:
an application profile;
primary security information;
secondary security information; and
a requested dual registration area;
receive, from the first node, a first response message comprising:
a coordinated expiration time;
a dual registration identifier; and
a combined allowed dual registration area; and
store information received in the first response message, wherein the stored information comprises:
the coordinated expiration time;
the dual registration identifier; and
the combined allowed dual registration area.

2. The apparatus of claim 1, wherein the apparatus comprises a multi-access edge computing application instance or an edge application instance.

3. The apparatus of claim 1, wherein the first node comprises an edge interworking service.

4. The apparatus of claim 1, wherein the first node comprises a primary dual registration system.

5. A method of performing a network function, the method comprising:
receiving, from an application server, a first request message comprising:
an application profile;
primary security information;
secondary security information; and
a requested dual registration area;
determining, based on the request message, whether to transmit a second request message to a primary dual registration system; and
in response to determining to transmit the second request message to the primary dual registration system, transmitting the second request message to the primary dual registration system, wherein the second request message comprises:
the application profile;
the primary security information; and
the requested dual registration area.

6. The method of claim 5, further comprising:
receiving, from the primary dual registration system, a second response message comprising:
a coordinated expiration time;
a dual registration identifier; and
a first allowed dual registration area.

7. The method of claim 6, further comprising:
in response to registration with the primary dual registration system being successful, transmitting a third request message to a secondary dual registration system, the third request message comprising:
the application profile;
the secondary security information;
the coordinated expiration time;
the dual registration identifier; and
the requested dual registration area.

8. The method of claim 7, further comprising:
receiving, from the secondary dual registration system, a third response message comprising:
the coordinated expiration time;
the dual registration identifier; and
a second allowed dual registration area.

9. The method of claim 8, further comprising:
transmitting, to the application server, a first response message comprising:
the coordinated expiration time;
the dual registration identifier; and
a combined allowed dual registration area determined based on the first allowed dual registration area and the second allowed dual registration area.

10. The method of claim 7, wherein the primary dual registration system, the secondary dual registration system, or a combination thereof comprises a multi-access edge computing platform or an edge enabler server.

11. The method of claim 5, wherein determining, based on the request message, whether to transmit the second request message to the primary dual registration system comprises determining based on: the application profile, primary registration pairing information, secondary registration system pairing information, locally stored dual registration information about whether to transmit the second request message to the primary dual registration system, or a combination thereof.

12. An apparatus for performing a network function, the apparatus comprising:
at least one memory; and
at least one processor coupled with the at least one memory and configured to cause the apparatus to:
receive, from an edge interworking service, a second request message comprising:
an application profile;
primary security information; and
a requested dual registration area; and
perform authorization for a primary registration based on: the primary security information, a local policy, the requested dual registration area, or a combination thereof.

13. The apparatus of claim 12, wherein the at least one processor is configured to cause the apparatus to, in response to the authorization for the primary registration being successful:
set a first allowed dual registration area specific to the primary dual registration system for an application server;
set a coordinated expiration time;
set a dual registration identifier; and
store information indicating the first allowed dual registration area, the coordinated expiration time, and the dual registration identifier.

14. The apparatus of claim 13, wherein the at least one processor is configured to cause the apparatus to transmit, to the edge interworking service, a second response message comprising:
the coordinated expiration time;
the dual registration identifier; and
the first allowed dual registration area.

15. The apparatus of claim 14, wherein the primary dual registration system comprises a multi-access edge computing platform or an edge enabler server.

16. A method of performing a network function at an apparatus, the method comprising:
transmitting, to a first node, a first request message comprising:
an application profile;
primary security information;
secondary security information; and
a requested dual registration area;
receiving, from the first node, a first response message comprising:
a coordinated expiration time;
a dual registration identifier; and
a combined allowed dual registration area
storing information received in the first response message, wherein the stored information comprises:
the coordinated expiration time;
the dual registration identifier; and
the combined allowed dual registration area.

17. The method of claim 16, wherein the apparatus comprises a multi-access edge computing application instance or an edge application instance.

18. The method of claim 16, wherein the first node comprises an edge interworking service.

19. The method of claim 16, wherein the first node comprises a primary dual registration system.
